(19) United States
(12) Patent Application Publication
(10) Pub. No.: US 2014/0176713 A1
(43) Pub. Date: Jun. 26, 2014

(54) VEHICULAR BIFOCAL REAR CAMERA SYSTEM

(71) Applicant: Continental Automotive Systems, Inc., (US)

(72) Inventor: Wai-Tak Ho, Hoffman Estates, IL (US)

(73) Assignee: CONTINENTAL AUTOMOTIVE SYSTEMS, INC., Auburn Hills, MI (US)

(21) Appl. No.: 13/726,081

(22) Filed: Dec. 22, 2012

(51) Int. Cl. B60R 11/04

(52) U.S. Cl. CPC B60R 11/04
USPC 348/148

(57) ABSTRACT

A rear camera system, and method, and an apparatus configured to provide at least a rear-view and a backup mode are described. The system comprises a controller communicatively coupled to the camera/lens/actuator device. The camera/lens/actuator device comprises a camera, a lens system, and an actuator. The lens system comprises at least two lens setups, a first setup configured for long distance vision and a second setup configured for short distance vision. The camera is in a movable relationship with the lens system, such that the camera and the lens system are configured to be aligned at the first setup when rear-view mode is engaged and at the second setup when backup mode is engaged. The actuator is configured to engage each of the rear-view and the backup modes.

### BRIEF DESCRIPTION OF THE DRAWINGS

For a more complete understanding of the disclosure, reference should be made to the following detailed description and accompanying drawings wherein:

FIG. 1 comprises a top schematic view of rear-view and backup camera viewing angles;

FIG. 2 comprises a side schematic view of rear-view and backup camera viewing angles;

FIG. 3 comprises a schematic view of an exemplary integrated rear-view and backup camera;

FIG. 4 comprises a schematic view of an exemplary lens system arrangement;

FIG. 5 comprises a schematic view of another exemplary lens system arrangement;

FIG. 6 comprises a schematic view of an exemplary rear camera system.

Skilled artisans will appreciate that elements in the figures are illustrated for simplicity and clarity and have not necessarily been drawn to scale. For example, the size dimensions and/or relative positioning of some of the elements in the figures may be exaggerated relative to other elements to help to improve understanding of various aspects of the present invention. Also, common but well-understood elements that are useful or necessary in a commercially feasible embodiment are often not depicted in order to facilitate a less obstructed view of these various aspects of the present invention. Furthermore, it will be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Vehicular rear camera systems are specialized video camera systems configured to aid the driver to see areas behind the vehicle where direct view from the driver's location is either obstructed by the vehicle or inconvenient for the driver to view directly. Although the systems are often referred to as “backup cameras”, “reversing cameras” and “rear-view cameras” interchangeably, the terms actually refer to two distinct functionalities.

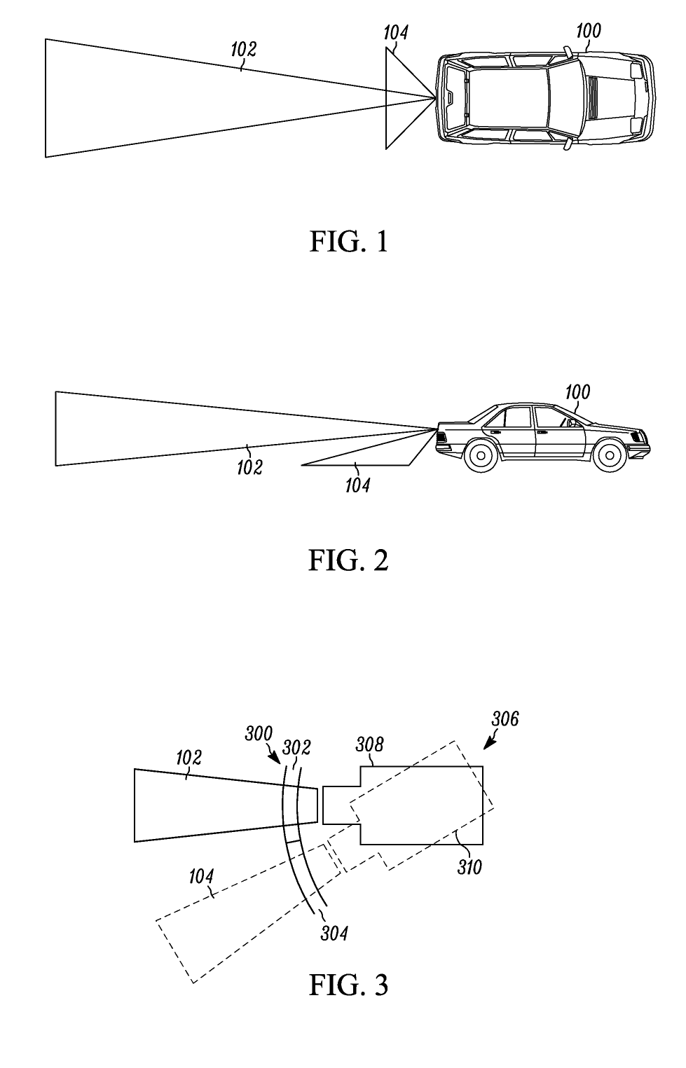

With reference to FIG. 1 and FIG. 2, a “backup camera” or “reversing camera” connotes the system's use for backing up a vehicle 100 where a view of objects proximate to the immediate rear of the vehicle is desirable. Accordingly, a backup camera typically produces a wide-angle somewhat downward view 104 of the area immediately behind the vehicle 100. Thus, if a rear-view mirror were present, a backup camera would typically serve only a complementary role.

In contrast, a “rear-view camera” connotes the system's use as a replacement to the rear-view mirror thus typically producing a rather narrow view 102 in a generally lateral direction of objects at a considerable distance from the vehicle 100. Accordingly, rear-view cameras are often used where a rear-view mirror is ineffective because of lack of lateral clearance behind the driver, such as, for example, in trailer trucks, motorhomes, or in vehicles where the driver is situated low to the ground.

In applications where both the backup and the rear-view functionality is desired the need is often addressed by mounting two independent cameras, one backup and one rear-view each with a distinct field of view. However, the need for respectively the rear-view and the backup functionality typically arises under distinct circumstances. Consequently, a single camera integrating the two functionalities is desirable for cost, complexity, size or weight reduction reasons.

With reference to FIG. 3, one way of integrating the rear-view and backup functionalities is to pivot the camera 306 to a generally lateral direction 308 when the rear-view functionality is desired, for example when the reverse gear is disengaged, and to at least somewhat downward direction 310 when the backup functionality is desired, for example when the reverse gear is engaged. While adequate for some applications, for example when the camera is mounted in a relatively high location, where the field of view of the camera in either direction is sufficient, this solution may not be adequate for applications where the camera is mounted relatively close to the ground or where the differences in the field of view requirements are more pronounced. Consequently, a system for changing the field of view of the camera is desired.

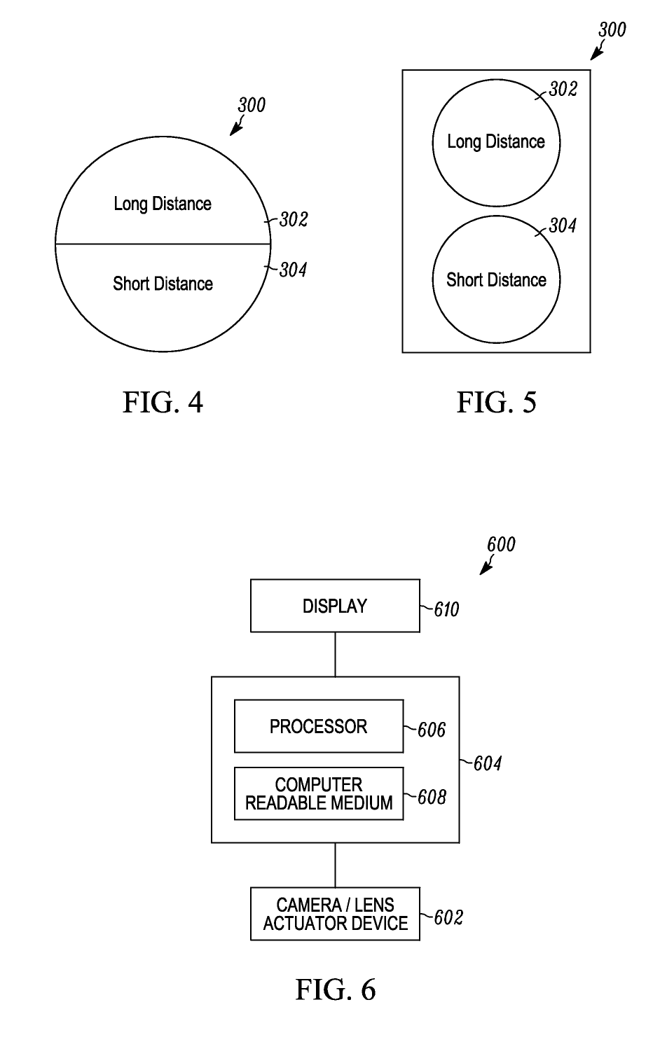

One way of changing the field of view of the camera is adjusting the lens system 300 from a long focal length setup 302 for distance vision 102 to a short focal length setup 304 for short distance vision 104. With reference to FIG. 4, in one example the lens system comprises two setups, the long distance 302, and the short distance 304, immediately adjacent another.

With reference to FIG. 5, in another example, the lens system comprises two setups, the long distance 302, and the short distance 304, at some distance from each other, for example to allow for greater radial separation. It should be understood that lens systems may include single lenses, compound lenses, filters, prisms, mirrors, or other optical elements, as well as any combinations of the foregoing.

Accordingly, a rear camera system is contemplated where the camera 306 while pivoting from a rear-view direction 308 to a backup direction 310 also pivots from a long focal length setup 302 to a short focal length setup 304. Moreover, it is contemplated that additional setups may be added when additional fields of view, magnifications, directions or otherwise are desired, for example where a mid-range view is desired. Furthermore, it is contemplated that the camera may be mounted in a still direction with the lens system providing the change in view direction. It is also contemplated that the camera may move in modes other than pivoting, in directions other than up and down, or may align in more than two directions. In addition, it is also contemplated that the lens systems may also shift independently of camera movement, if any, to facilitate different views, fields of view, magnifications or otherwise.

With reference to FIG. 6, the rear camera system 600 comprises a controller 604 communicatively coupled to a camera/lens/actuator device 602. The camera/lens/actuator device 602 comprises a camera, a lens system, and an actuator. The lens system comprises at least two lens setups the first setup and the second setup. The camera is in a movable relationship with the lens system, such that the camera and the lens system are configured to be aligned at the first setup when rear-view mode is engaged and at the second setup when backup mode is engaged. The actuator is configured to engage each of the rear-view and the backup modes. The controller 604 comprises at least one processor 606 communicatively coupled to a computer readable medium 608, the computer readable medium not being a transient signal, the medium configured to store data or instructions executable by at least one processor for controlling the actuation each of the rear-view and the backup modes. The controller 604 is optionally communicatively coupled to a display 610, the display 610 configured to display images from the camera. In an example, the rear camera system is configured to be mounted to a vehicle. In an aspect the rear camera system is mounted to a vehicle.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention. Further, those skilled in the art will recognize that the approaches described herein may also be used in other vision and optical systems.

What is claimed is:

1. A rear camera apparatus comprising:
a camera; and
a lens system comprising at least two lens setups, a first setup configured for long distance vision, and a second setup configured for short distance vision;
the camera being in a movable relationship with the lens system, such that the camera and the lens system are configured to be aligned at the first setup when rear-view mode is engaged and at the second setup when backup mode is engaged.

2. The apparatus as recited in claim 1, wherein the rear-view mode is engaged when a vehicle's reverse driving mode is disengaged.

3. The apparatus as recited in claim 1, wherein the backup mode is engaged when a vehicle's reverse driving mode is engaged.

4. The apparatus as recited in claim 1, wherein the camera is configured to align with lens system at one of the first and second setups.

5. The apparatus as recited in claim 1, wherein the lens system is configured to align with the camera at one of the first and second setups.

6. The apparatus as recited in claim 1, wherein the first setup is immediately adjacent the second setup.

7. The apparatus as recited in claim 1, wherein the first setup is distal from the second setup.

8. The apparatus as recited in claim 1, wherein the first setup is a relatively long focal length setup and the second setup is a relatively short focal length setup.

9. The apparatus as recited in claim 1, further comprising an actuator configured to align the camera with each of the first and the second setup.

10. A rear camera system comprising:
a controller communicatively coupled to the camera/lens/actuator device;
the camera/lens/actuator device comprising a camera, a lens system, and an actuator;
the lens system comprising at least two lens setups, a first setup configured for long distance vision, and a second setup configured for short distance vision;
the camera being in a movable relationship with the lens system, such that the camera and the lens system are configured to be aligned at the first setup when rear-view mode is engaged and at the second setup when backup mode is engaged;
the actuator configured to engage each of the rear-view and the backup modes.

11. The rear camera system as recited in claim 10, wherein the controller comprises at least one processor and a computer readable medium, the medium configured to store data or instructions executable by at least one processor for controlling the actuation of each of the rear-view and the backup modes.

12. The rear camera system as recited in claim 10, wherein the actuator is configured to align the camera with the lens system at each one of the first and second setups.

13. The rear camera system as recited in claim 10, wherein the actuator is configured to align the lens system with the camera at each one of the first and second setups.

14. The rear camera system as recited in claim 10, wherein the controller is configured to command the engagement of the rear-view mode in response to disengagement of a vehicle's reverse driving mode.

15. The rear camera system as recited in claim 10, wherein the controller is configured to command the engagement of the backup mode in response to engagement of a vehicle's reverse driving mode.

16. The rear camera system as recited in claim 10, wherein the first setup is a relatively long focal length setup and the second setup is a relatively short focal length setup.

17. The rear camera system as recited in claim 10, further comprising a display, the display configured to display images from the camera.

18. The rear camera system as recited in claim 10, further comprising a display, the display being communicatively coupled to the controller.

19. The rear camera system as recited in claim 10, further comprising a vehicle;
wherein the controller and the camera/lens/actuator device are mounted to the vehicle.

20. The rear camera system as recited in claim 19, further comprising a display, the display configured to display images from the camera.
